(19) United States
(12) Patent Application Publication
(10) Pub. No.: US 2016/0004192 A1
(43) Pub. Date: Jan. 7, 2016

(54) IMAGE FORMING APPARATUS

(71) Applicants: Wakana Itoh, Kanagawa (JP); Hiroyuki Kunii, Kanagawa (JP); Masayoshi Nakayama, Kanagawa (JP); Kazuaki Kamihara, Tokyo (JP); Takuma Higa, Kanagawa (JP)

(72) Inventors: Wakana Itoh, Kanagawa (JP); Hiroyuki Kunii, Kanagawa (JP); Masayoshi Nakayama, Kanagawa (JP); Kazuaki Kamihara, Tokyo (JP); Takuma Higa, Kanagawa (JP)

(73) Assignee: RICOH COMPANY, LTD., Tokyo (JP)

(21) Appl. No.: 14/740,992

(22) Filed: Jun. 16, 2015

(30) Foreign Application Priority Data
Jul. 1, 2014 (JP) 2014-135603

(51) Int. Cl. G03G 15/01

(52) U.S. Cl. CPC G03G 15/162

(57) ABSTRACT

An image forming apparatus has a system speed of from 400 to 2,000 mm/sec and includes an endless intermediate transfer belt to transfer a sheet-shaped medium bearing an image formed of a toner. The intermediate transfer belt includes a first layer including at least a substrate; a second layer; and an electric resistance controlling material and has a surface resistivity of from 1×10⁸ to 1×10¹³ Ω/□, a volume resistivity of from 1×10⁶ to 1×10¹² Ω·cm, and a surface roughness not greater than 50 μm. The toner includes a mother particle which is surface-treated with a fluidizer, comprising a charge controlling agent and at least two external additives which are inorganic particulate materials and particulate polymers formed of polymeric particulate materials or thermosetting resins adhering to the surface of the mother particle.

### CROSS-REFERENCE TO RELATED APPLICATIONS

This patent application is based on and claims priority pursuant to 35 U.S.C. §119 to Japanese Patent Application No. 2014-135603, filed on Jul. 1, 2014, in the Japan Patent Office, the entire disclosure of which is hereby incorporated by reference herein.

### BACKGROUND

1. Technical Field

The present invention relates to an image forming apparatus having a system speed of from 400 to 2,000 mm/sec, including a transfer using an elastic intermediate transfer belt, and using a toner including a charge controlling agent, which is formed from a mother particle subjected to a surface treatment with an external additive.

2. Description of the Related Art

In recent years, higher speed and higher image quality have typically been demanded in electrophotographic fields.

However, image quality deteriorates as imaging speed, i.e., system speed in image forming apparatus becomes higher. Particularly, since void images largely influencing upon image quality become worse, higher speed without void images is needed.

In an electrophotographic image forming apparatus such as laser printers and copiers, a toner image is partially untransferred on occasion to form a white spot, i.e., a void image when secondly transferred from an intermediate transferer onto a recording material having convexities and concavities such as non-smooth papers and envelopes.

The main causes of the void image include lowering of contactness between the intermediate transferer and the recording material due to the convexities and concavities of the recording material; and deterioration of a toner such as strong adherence of the mother toner particle, low fluidity of the toner and unstable chargeability thereof.

Therefore, to avoid void images as the system speed becomes higher, it is necessary to increase the contactness between the intermediate transferer and the recording material, keep low adherence of a mother toner particle, increase fluidity of a toner and improve stability of the chargeability thereof.

Japanese published unexamined applications Nos. JP-2001-42666-A and JP-2002-268285-A disclose a transferer using an elastic body on the surface to increase the contactness between the intermediate transferer and the recording material.

However, when the intermediate transferer is an endless belt formed of a rubber elastic body, an image on the intermediate transferer expands and contracts due to variation of a tensile strength of the endless belt, and particularly a color image has a color registration error.

In connection with this, the contactness between the intermediate transferer and the recording material when the system linear speed is high is not optimized, and the color registration error of a color image tends to be more noticeable.

In addition, Japanese published unexamined applications Nos. JP-2001-42666-A and JP-2002-268285-A disclose a method of controlling a surface resistivity of the intermediate transferer to transfer a high-quality toner image formed on the surface of a photoreceptor onto the transfer material without distortion.

However, the contactness between the intermediate transferer and the recording material when the system linear speed is high is not optimized, and the color registration error of a color image is thought to be worse.

Japanese published unexamined applications Nos. JP-2006-308979-A discloses an image forming apparatus including a means of pressing a toner layer formed on the intermediate transferer before the second transferer at upstream side of the intermediate transferer in a rotational direction to prevent defective transfer image. This does not relate to an intermediate transferer.

Japanese published unexamined applications Nos. JP-2007-4081-A discloses an intermediate transfer belt including a substrate having high Young modulu's (2500 to 8000 Mpa) and less belt displacement due to stress and a photoconductive layer thereon through or not through an elastic intermediate layer. However, this does not aim at improving contactness between the intermediate transferer and the recording material.

Japanese published unexamined applications Nos. JP-2008-209848-A discloses an intermediate transfer having a volume resistivity of from 1×10⁷ to 1×10¹¹ Ω/□. However, this does not optimize the contactness between the intermediate transferer and the recording material when the system linear speed is high as the Japanese published unexamined applications Nos. JP-2001-42666-A and JP-2002-268285-A do not.

Japanese published unexamined applications Nos. JP-2008-268435-A discloses a color toner applied with an external additive including particulate titanium oxide having a volume resistivity of from 1×10⁵ to 1×10¹⁰ Ω·cm. However, this does not optimize the contactness between the intermediate transferer and the recording material when the system linear speed is high, either.

As mentioned above, the intermediate transferer including an elastic body at the surface or having a controlled surface resistivity prevents void images. However, in high-speed systems, a technique of increasing contactness between the intermediate transferer and the recording material and keeping adherence of mother toner particles low is not optimized, resulting in void images.

### SUMMARY

Accordingly, one object of the present invention is to provide an image forming apparatus capable of preventing void images to improve image quality.

This object of the present invention, either individually or collectively, has been satisfied by the discovery of an image forming apparatus having a system speed of from 400 to 2,000 mm/sec and including an endless intermediate transfer belt to transfer a sheet-shaped medium bearing an image formed of a toner, wherein the intermediate transfer belt includes a first layer including at least a substrate; a second layer having a thickness of from 200 to 2,000 μm and overlying the first layer, formed of an elastic body, on the surface of which spherical particulate resins having a volume-average particle diameter of from 0.5 to 5.0 μm are located in a surface direction to form concavities and convexities; an electric resistance controlling material, having a surface resistivity of from 1×10⁸ to 1×10¹³ Ω/□, a volume resistivity of from 1×10⁶ to 1×10¹² Ω·cm, and a surface roughness not greater than 50 μm; and the toner includes a mother particle which is surface-treated with a fluidizer, including a charge controlling agent and at least two external additives which are inorganic particulate materials and particulate polymers formed of polymeric particulate materials or thermosetting resins adhering to the surface of the mother particle.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the image forming apparatus of the present invention;

FIG. 2 is a schematic view illustrating an embodiment of layer composition of the intermediate transfer belt of the present invention;

FIG. 3 is a schematic view illustrating an embodiment of apparatus for applying and fixing powder particles in the present invention;

FIG. 4 is a schematic view illustrating an embodiment of apparatus for coating the substrate and the elastic body in the present invention; and

FIGS. 5A and 5B are schematic views illustrating void images when function evaluation results thereof are fair and poor, and those when function evaluation results thereof are excellent and good, respectively.

### DETAILED DESCRIPTION

The present invention provides an image forming apparatus capable of preventing void images to improve image quality.

Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

### [Image Forming Apparatus]

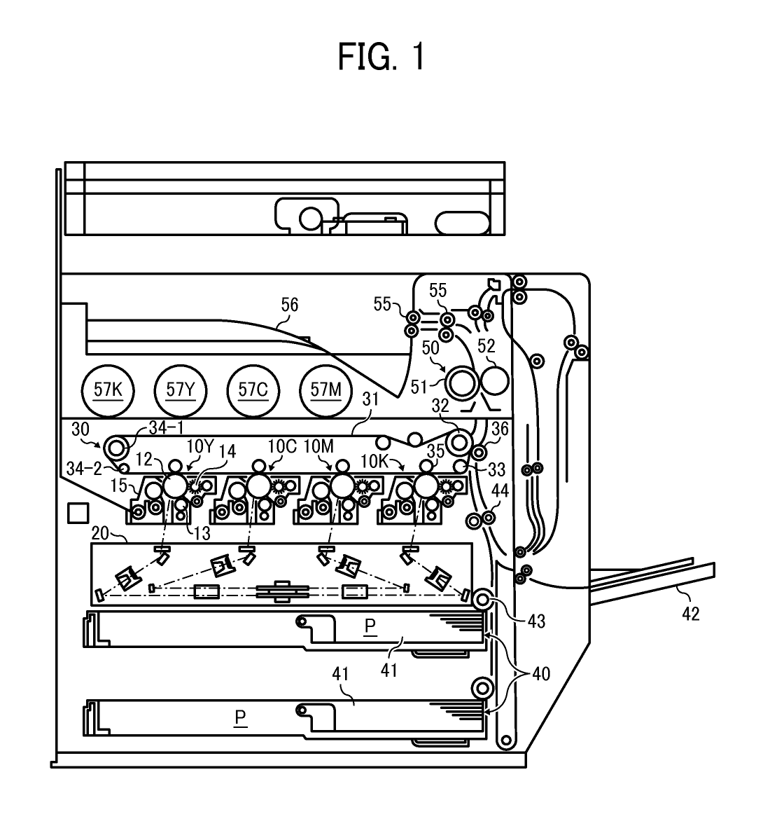

FIG. 1 is a schematic view illustrating an embodiment of the image forming apparatus equipped with an intermediate transfer belt unit (intermediate transferer) of the present invention.

The image forming apparatus includes image formers for four colors. i.e., 10Y (yellow), 10C (cyan), 10M (magenta) and 10K (black) detachable from relative image forming stations, an optical unit 20 as an irradiator capable of irradiating a laser beam, a transfer electric field forming unit 30, a paper feed unit 40 and a fixing unit 50.

Each of the image formers 10Y (yellow), 10C (cyan), 10M (magenta) and 10K (black) has the same configuration integrally including a photoreceptor drum 12 as an image bearer, a charger 13 charging the photoreceptor drum 12 and a cleaner 14 removing a developer remaining on the photoreceptor drum 12. An image developer 15 developing a latent image formed on the photoreceptor drum 12 is connected to each of the image formers. Each of the image formers is detachable from the image forming apparatus in an opening and closing direction of an openable plate mentioned later (rotational axial direction of the photoreceptor)

The transfer electric field forming unit 30 includes a transfer belt 31 which is an endless rotational member as a transfer electric field forming member, and four rollers 32, 33 34-1 and 34-2 rotatably supporting the transfer belt 31. Further, the transfer electric field forming unit 30 includes a first transfer roller 35 equivalent to a transfer electric field forming member for transferring a toner image formed on each of the photoreceptor drum 12 onto the transfer belt 31, and a second transfer roller 36 equivalent to a transfer electric field forming member for further transferring the toner image transferred on the transfer belt 31 onto a recording paper P.

The paper feed unit 40 includes a paper feed roller 43 and a registration roller 44 transferring a recording paper P to a second transfer area from a paper feed cassette 41 or a manual paper feed tray 42.

The fixing unit 50 includes a fixing roller 51 and a pressure roller 52, and applies a heat and a pressure to a toner image on a recording paper P to fix the toner image thereon.

First, in the image former 10Y, after the photoreceptor drum 12 is uniformly charged by the charger 13, the optical unit 20 irradiates the surface of the photoreceptor drum 12 with a laser beam to form an electrostatic latent image thereon, and the image developer 15 develops the electrostatic latent image to form a toner image.

The toner image formed on the photoreceptor drum 12 is transferred onto the transfer belt 31 by the first transfer roller 35. The photoreceptor drum 12 having transferred the toner image is cleaned by the cleaner 14, and ready for the following image formation. A residual toner collected by the cleaner 14 is stored in an unillustrated waste toner collection bottle located in a takeoff direction of the image former (rotational axial direction of the photoreceptor drum 12). The waste toner collection bottle is detachable from the image forming apparatus to be exchanged when filled.

The same image forming process is performed in each of the image formers 10C, 10M and 10K as well to form each color toner image, and is sequentially overlapped on the previously formed toner image.

Meanwhile, a recording paper P is transferred to the second transfer area by the paper feed cassette 41 or the manual paper feed tray 42, and the toner image formed on the transfer belt 31 is transferred onto the recording paper P by the second transfer roller 36. The recording paper P the toner image is transferred on is transferred to the fixing unit 50, the toner image is fixed at a nip between the fixing roller 51 and the pressure roller 52, and discharged onto a paper discharge tray 56 by a paper discharge roller 55.

Each of toner bottles 57Y, 57C, 57M and 57K is rotated to feed a new toner to each of the image formers 10Y, 10C, 10M and 10K through a pipe.

### [Intermediate Transfer Belt]

FIG. 2 is a schematic view illustrating an embodiment of layer composition of the intermediate transferer (intermediate transfer belt) which is one of main elements of the present invention. In FIG. 2, on a flexuous and stiff substrate 31-1, a flexible elastic body 31-2 is layered. A layer of a spherical particulate resin 31-3 is formed on the surface of the elastic body 31-2.

However, in the present invention, an intermediate layer may be formed between the substrate and the elastic body layer for the purpose of, e.g. improving adhesiveness therebetween or controlling electrical resistance and electrostatic capacity of the intermediate transfer belt.

### (Substrate)

The substrate 31-1 is formed of a resin including an electrical resistance adjuster. In terms of non-flammability, fluorine-containing resins such as PVDF and ETFE, polyimide resins or polyamideimide resins are preferably used as the resin. Particularly, the polyimide resins or polyamideimide resins are more preferably used in terms of mechanical strength (high elasticity).

The electrical resistance adjuster includes metal oxides, carbon black, ion conductivizers, conductive polymers, etc.

Specific examples of the metal oxides include zinc oxide, tin oxide, zirconium oxide, aluminum oxide, silicon oxide, etc. Surface-treated metal oxides having better dispersibility can also be used.

Specific examples of the carbons black include ketjen black, furnace black, acetylene black, thermal black, gas black, etc.

Specific examples of the ion conductivizers include tetraalkylammonium salts, trialkylbenzylammonium salts, alkylsulfonic acid salts, alkylbenzenesulfonic acid salts, alkylsulfates, glycerin fatty acid esters, sorbitan fatty acid esters, polyoxyethylenealkylamine, polyoxyethylene fatty alcohol esters, alkylbetaines, lithium perchlorate, etc. These can be sued alone or in combination.

The electrical resistance adjusters of the present invention are not limited to the above-mentioned compounds. A coating liquid including at least a resin for preparing the transfer electric field forming member may further include additives such as a dispersion aid, a reinforcing agent, a lubricant and an antioxidant when necessary.

The transfer electric field forming member preferably includes the electrical resistance adjuster so as to have a surface resistivity of from 1×10⁸ to 1×10¹³ Ω/□, and a volume resistivity of from 1×10⁶ to 1×10¹² Ω·cm. The content of the electrical resistance adjuster should be in such a range that the layer is neither brittle nor cracked.

Namely, a coating liquid in which the contents of the resin component, e.g., polyimide resin precursors or polyamide imide resin precursor, and the electrical resistance adjuster are properly controlled is preferably used to prepare a transfer electric field forming member having a good balance between electrical properties (surface resistivity and volume resistivity) and mechanical strength.

The content of the electrical resistance adjuster when being carbon black in the coating liquid is preferably from 10% to 25% by weight, and more preferably from 15% to 20% by weight per 100% by weight of solid contents in the liquid. The content of the electrical resistance adjuster when being metal oxide in the coating liquid is preferably from 1% to 50% by weight, and more preferably from 10% to 30% by weight per 100% by weight of solid contents in the liquid. When the content is less than the range, the effect of the electrical resistance adjuster is not sufficiently obtained. When greater than the range, the transfer electric field forming member deteriorates in mechanical strength.

### (Elastic Body)

Next, the elastic body 31-2 layered on the substrate 31-1 is explained.

The elastic body 31-2 can be formed of conventional resins, elastomers, rubbers, etc. The elastomers and rubbers having sufficient flexibility (elasticity) to fully exert an effect of the embodiment of the present invention are preferably used.

The elastomers include thermoplastic elastomers such as polyester elastomer, polyamide elastomers, polyether elastomers, polyurethane elastomers, polyolefin elastomers, polystyrene elastomers, polyacrylic elastomers, polydiene elastomers, silicone-modified polycarbonate elastomers, fluorine-containing copolymer elastomers; and thermosetting elastomers such as polyurethane elastomers, silicone-modified epoxy elastomers and silicone-modified acrylic elastomers.

The rubbers include isoprene rubbers, styrene rubbers, butadiene rubbers, nitrile rubbers, ethylene-propylene rubbers, butyl rubbers, silicone rubbers, chloroprene rubbers, acrylic rubbers, chlorosulfonated polyethylene rubbers, fluorine-containing rubbers, urethane rubbers, hydrin rubbers, etc. It is preferable these are at least partially cured.

The softer, the better the elastomers or the rubbers to follow concavities and convexities on papers such as LEATHAC paper.

In this embodiment, the thermosetting materials are more preferably used than the thermoplastic materials because a spherical particulate resin layer is formed thereon, and the thermosetting materials well adhere to resins. A vulcanized rubber is preferably used as well.

In addition to the above materials, a resistivity adjuster for adjusting electrical properties, a flame retardant for non-flammability, an antioxidant, a stiffener, a filler, a vulcanization accelerator, etc. are included when necessary.

As the resistivity adjuster, it is preferable carbon black or metal oxides are not used so much because of impairing flexibility. Ion conductivizers and conductive polymers are effectively used. These can be used in combination.

The elastic body 31-2 preferably has a surface resistivity of from 1×10⁸ to 1×10¹³ Ω/□, and a volume resistivity of from 1×10⁶ to 1×10¹² Ω·cm.

The belt preferably has a surface roughness not greater than 50 μm, and more preferably not greater than 10 μm. When greater than 50 μm, the belt deteriorates in followability to the surface of a transfer medium and transfer pressure.

The elastic body 31-2 preferably has a thickness of from 200 μm to 2 mm. When too thin, followability to the surface of a transfer medium and transfer pressure lower. When too thick, the belt is so heavy that it is likely to bend and unstably runs. In addition, the belt is likely to have a crack at a flexure contacting a roller suspending the belt.

The spherical particulate resin 31-3 is formed of, but not limited to, acrylic resins, melamine resins, polyamide resins, polyester resins, silicone resins, fluorine-containing resins, etc. The surface of the particulate resin may be treated with different materials. The particulate resin includes rubber materials. The surface of the rubber-made particulate material may be coated with a hard resin. The spherical particulate resin 31-3 may be hollow or porous.

The silicone resin is most preferably used because of having lubricity and imparting releasability and abrasion resistance to a toner.

The spherical particulate resin 31-3 is preferably formed spherical by polymerization methods, etc. with the resin. The higher the sphericity, the more preferable.

The spherical particulate resin 31-3 preferably has a volume-average particle diameter of from 0.5 to 5.0 μm, and is monodispersed, having a sharp particle diameter distribution. When too small, the transferability is not sufficiently improved. When too large, the surface roughness and a gap between the particles become large, resulting in defective transfer of a toner and defective cleaning. Further, the spherical particulate resin 31-3 is mostly insulative, and when too large, charge potential remains and accumulates, resulting in image distortion when images are continuously produced.

The elastic body of the intermediate transfer belt in the embodiment preferably has a compression Young's modulus of from 0.5 to 80.0 Mpa/m² in a stress range of from 3 to 50 N/mm² in consideration of a nip pressure range when a toner image is transferred.

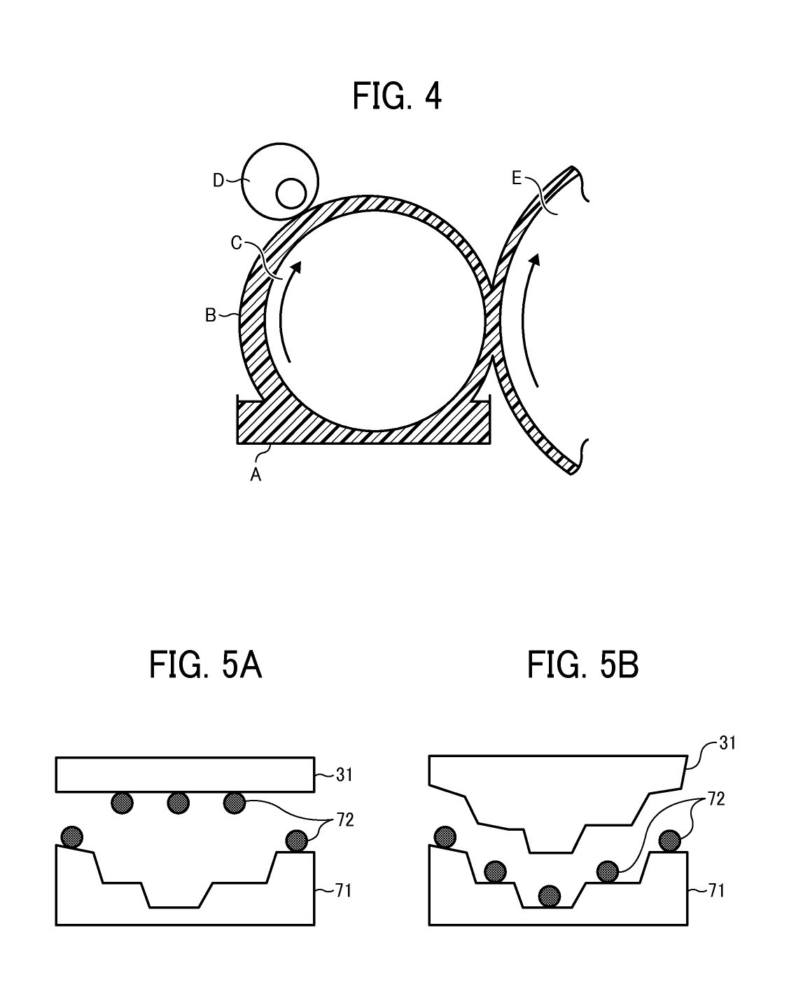

FIG. 4 is a schematic view illustrating an embodiment of apparatus for coating the substrate and the elastic body in the present invention. A method of preparing the belt of this embodiment is explained.

First, a method of preparing the substrate is explained.

A method of preparing the substrate using a coating liquid including at least a resin, i.e., the polyimide precursor or the polyamideimide precursor is explained.

The coating liquid is coated on the surface of a cylindrical substrate by spiral coating with a nozzle or a dispenser, die coating with a wide die or roll coating with a roll. The roll coating is explained. In FIG. 4, A is a coating pan for reserving a defoamed precursor liquid as a coating liquid, B is a precursor liquid, C is a coating roller continuously drawing the coating liquid from the coating pan A. D is a regulation roller for the coating liquid to have a predetermined thickness in a gap with the coating roller C. E is a cylindrical substrate (metallic mold) the coating liquid having a predetermined thickness is transferred onto.

First, the fully defoamed precursor liquid is placed in the coating pan. The liquid preferably has a viscosity of from 0.5 to 10 Pa·s with an organic solvent. Next, the bottom of the coating roller is dipped in the coating pan the liquid was placed in, and the coating roller is rotated at a low peripheral speed of from 10 to 100 mm/sec to draw the liquid.

Then, the regulation roller located above the coating roller regulates the thickness of the liquid on the coating roller in a gap therewith. The thickness is preferably twice as much as that transferred onto the cylindrical substrate.

Next, the cylindrical substrate E is put close to the coating roller C while slowly rotated leaving a gap not larger than the thickness of the liquid on the coating roller. The liquid on the coating roller is transferred onto the cylindrical substrate E rotating in the same direction of the coating roller C (clockwise in FIG. 4) to have a predetermined thickness thereon.

After coated, the cylindrical substrate E is gradually heated while rotated to vaporize a solvent in the coated layer at from 80 to 150° C. In this process, it is preferable that the atmospheric vapor such as vaporized solvent is efficiently circulated to remove. When a self-supportive layer is formed, the cylindrical substrate E the layer is formed on is placed in a heating (firing) furnace and heated in stages, and heated (fired) at high temperature of from 250 to 450° C. finally to fully imidize or polyamideimidize the polyimide precursor or the polyamideimide precursor.

After the substrate is fully cooled, an elastic body is layered thereon. A rubber coating liquid including a rubber dissolved in an organic solvent is coated on the substrate, and then the solvent is dried and vulcanized. Coating methods include the same methods used for forming the substrate, i.e., spiral coating, die coating and roll coating. The die coating and the spiral coating are preferably used to form a thick elastic body having good transferability on concave and convex transfer media. The spiral coating is explained. While the substrate is rotated in a circumferential direction, the rubber coating liquid is continuously fed to a round or a wide nozzle and the nozzle is moved to an axial direction of the substrate to spirally coating the liquid on the substrate. The coating liquid spirally coated on the substrate is dried while leveled at a predetermined rotation speed and temperature.

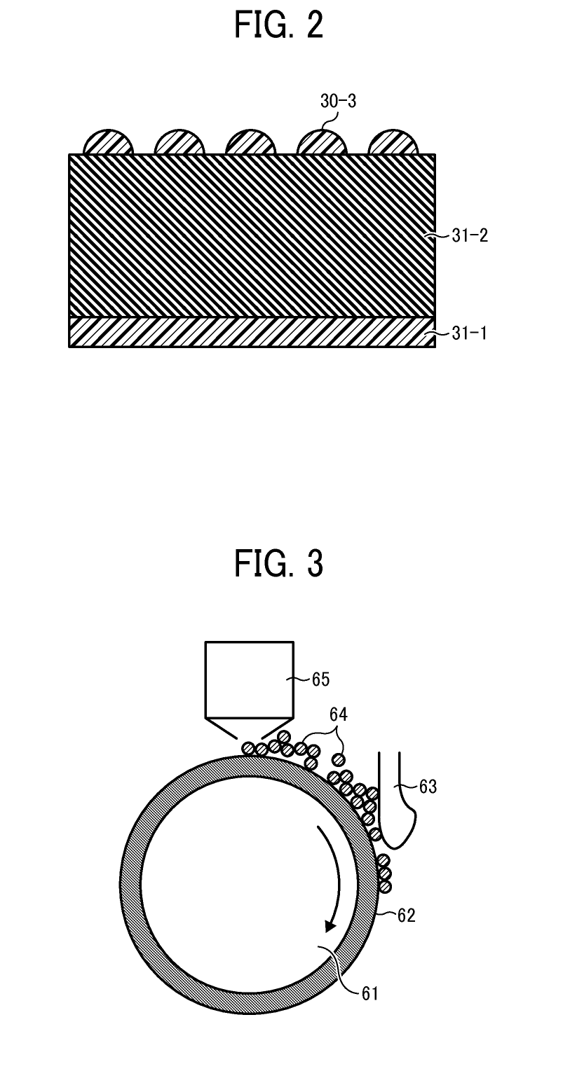

After the coating liquid is fully levelled, a powder applicator 61 and a pressing member 62 are located as shown in FIG. 3 to uniformly apply a spherical particulate material with the powder applicator 61 on the surface of the coated substrate while rotated and press the spherical particulate material at a constant pressure with the pressing member 62. The pressing member 62 removes extra particles while burying the spherical particulate material in the elastic body.

After a uniform particle layer is formed, the layer is heated at a specified temperature for a specified time to be cured to form an elastic body.

After fully cooled, the substrate with the elastic body is released from the metallic mold to form a desired intermediate transfer belt.

### [Toner]

A toner for use in the present invention is explained.

The toner mother particle in the present invention preferably has a glass transition temperature (Tg) of from 20° C. to 70° C. when measured by DSC before applied with an external additive, and preferably from 30° C. to 105° C. after applied therewith.

The external additive decreases adhesiveness and cohesiveness of a binder resin in the mother particle because of being heated in the apparatus without changing high-speed sharp meltability thereof for high system speed, and void images.

The toner of the present invention preferably includes a mother particle formed of a colored particle granulated by emulsifying or dispersing an oil phase including a solvent including toner materials in an aqueous medium to prepare an emulsion or a dispersion, and removing solvent therefrom.

For the purpose of assisting fluidity, developability, chargeability and cleanability of the mother particle, inorganic particulate materials such as large-size silica, small-size silica and titanium oxide are preferably used as the external additive.

Specific examples of the inorganic particulate materials include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc. In addition, particles of polymers such as polymers prepared by a soap-free emulsion polymerization or a suspension polymerization (e.g., polystyrene, and (meth)acrylic ester copolymers), polycondensation polymers such as silicone resins, benzoguanamine resins, and nylon resins, and thermosetting polymers can also be used as external additives.

The external additive preferably has a particle diameter of from 25 nm to 2 μm, particularly the large-size silica preferably has a particle diameter of from 25 to 270 nm, and the small-size silica preferably has a particle diameter of from 1 to 270 nm.

The large-size silica preferably has a coverage over the parent particulate material of from 5 to 45%. The toner formed of a mother particle after applied with the external additive preferably has a BET specific surface area of from 20 to 500 m²/g

The toner preferably includes the inorganic particulate material in an amount of from 0.1 to 12 parts by weight. A ratio of a total weight of the large-size silica and the small-size silica to that of the titanium oxide (large-size silica+small-size silica)/titanium oxide) is preferably from 1 to 10.

The content of a charge controlling agent in the toner of the present invention is determined depending on the variables such as choice of binder resin, presence of additives, and dispersion method. In general, the content of a charge controlling agent is preferably from 0.1 parts to 10 parts by weight, and more preferably from 0.2 parts to 5 parts by weight, per 100 parts by weight of the binder resin included in the toner.

When the content is greater than 10 parts by weight, the charge quantity of the toner excessively increases, thereby excessively increasing the electrostatic attraction between the developing roller and the toner, resulting in deterioration of fluidity and decrease of image density.

When the charge controlling agent is included in the toner, a method in which the charge controlling agent is preliminarily kneaded together with a master batch or a binder resin, the mixture is dissolved in a solvent, and the solution is added when other toner components such as binder resins and release agents are mixed to prepare an oil phase liquid; a method in which the charge controlling agent is directly added to a solvent together with other toner components such as binder resins and release agents to prepare an oil phase liquid; a method in which after preparing toner particles, the charge controlling agent is mixed with the toner particles to be fixed thereto, and the like method can be used.

Suitable examples of the charge controlling agents include Nigrosine dyes, triphenyl methane dyes, chromium-containing metal complex dyes, molybdic acid chelate pigments, Rhodamine dyes, alkoxyamines, quaternary ammonium salts, fluorine-modified quaternary ammonium salts, alkylamides, phosphor and its compounds, tungsten and its compounds, fluorine-containing activators, metal salts of salicylic acid, metal salts of salicylic acid derivatives, etc. Specific examples of the marketed charge controlling agents include BONTRON 03 (Nigrosine dye), BONTRON P-51 (quaternary ammonium salt), BONTRON S-34 (metal-containing azo dye), BONTRON E-82 (metal complex of oxynaphthoic acid), BONTRON E-84 (metal complex of salicylic acid), and BONTRON E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and COPY CHARGE NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as a sulfonate group, a carboxyl group, a quaternary ammonium group, etc.

The toner materials may include a colorant. Suitable materials for use as the colorant include known dyes and pigments. Specific examples of such dyes and pigments include carbon black, Nigrosine dyes, black iron oxide, NAPHTHOL YELLOW S, HANSA YELLOW 10G, HANSA YELLOW 5G, HANSA YELLOW G, Cadmium Yellow, yellow iron oxide, loess, chrome yellow, Titan Yellow, polyazo yellow, Oil Yellow, HANSA YELLOW GR, HANSA YELLOW A, HANSA YELLOW RN, HANSA YELLOW R, PIGMENT YELLOW L, BENZIDINE YELLOW G, BENZIDINE YELLOW GR, PERMANENT YELLOW NCG, VULCAN FAST YELLOW 5G, VULCAN FAST YELLOW R, Tartrazine Lake, Quinoline Yellow LAKE, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED F2R, PERMANENT RED F4R, PERMANENT RED FRL, PERMANENT RED FRLL, PERMANENT RED F4RH, Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE RS, INDANTHRENE BLUE BC, Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and their mixtures, etc. The content of the colorant in the toner is preferably from 1% to 15% by weight, and more preferably from 3% to 10% by weight of the toner.

A toner formed of a mother particle granulated by emulsifying or dispersing an undiluted liquid (oil phase) of toner materials in an aqueous medium (phase) in the shape of an oil drop, and removing a solvent is, i.e., one of chemical toners comparable to pulverization toners. The chemical toners include various toners, e.g., a toner formed by a method of spraying an organic solvent in which toner materials are dissolved or dispersed to form a spherical mother particle and a toner including a binder which is a complete polymerization resin synthesized from monomers, i.e., a complete polymerization toner. However, in the present invention, a mother particle is formed by a method using an aqueous phase in which a lipophilic or hydrophobized solid particulate material is dispersed, and the solid particulate material transfers from the aqueous phase to an oil drop and adheres on the surface thereof in a process of dispersion to form a suitable O/W dispersion with the undiluted liquid (oil phase). After the de-solvent process, a hard shell formed of the sold particulate material is formed on the surface of the resultant toner mother particle. Therefore, the external additive added later can keep adhering to the surface of the particle for long periods without penetrating into the mother particle even when including a binder resin having low-temperature sharp meltability, which improves fluidity thereof and prevents aggregation thereof. The solid particulate material dispersed in the aqueous phase includes particulate resins and hydrophobized solid particulate materials. The solid particulate material is preferably used, but is not essential in the present invention.

Specific examples of the particulate resin include any thermoplastic and thermosetting resins capable of forming a dispersion element such as vinyl resins, a polyurethane resin, an epoxy resin, a polyester resin, a polyamide resin, a polyimide resin, silicon resins, a phenol resin, a melamine resin, a urea resin, an aniline resin, an ionomer resin, a polycarbonate resin, etc. These resins can be used alone or in combination.

Among these resins, the vinyl resins, the polyurethane resin, the epoxy resin, the polyester resin and their combinations are preferably used in terms of forming an aqueous dispersion of microscopic spherical particulate resins. Specific examples of the vinyl resins include homopolymerized or copolymerized polymers such as styrene-(metha)esteracrylate resins, styrene-butadiene copolymers, (metha)acrylic acid-esteracrylate polymers, styrene-acrylonitrile copolymers, styrene-maleic acid anhydride copolymers and styrene-(metha)acrylic acid copolymers. The particulate resin preferably has an average particle diameter of from 5 to 200 nm, and more preferably from 20 to 300 nm. Inorganic compound dispersants such as tricalcium phosphate, calcium carbonate, titanium oxide, colloidal silica and hydroxyapatite, etc. can be used as well.

### (Hydrophobized Inorganic Particulate Material)

Specific examples of the hydrophobized inorganic particulate material include hydrophobized silica, titania, alumina zinc oxide, tin oxide, etc. Particularly, the particulate silica has high negative chargeability and is fixed on a particulate pigment by clone power stronger than that of the inorganic particulate material having comparatively high electroconductivity such as the titania, alumina zinc oxide and tin oxide.

Specific examples of a hydrophobizer include silane coupling agents, silane coupling agents having a fluoroalkyl group, silylating agents, organic titanate coupling agents, aluminum coupling agents, silicone oils, modified silicone oils, etc. In addition, many of the hydrophobized inorganic particulate materials are commercially available.

An embodiment of a toner formed of a mother particle granulated by emulsifying or dispersing an undiluted liquid (oil phase) of toner materials in an aqueous medium (phase) in the shape of an oil drop, and removing a solvent in the present invention is explained. The mother particle in the present invention preferably includes, but are not limited to, polyester resins as a binder resin having low-temperature sharp meltability in compliance with needs for saving energy, higher speed and higher image quality these days. The polyester resins preferably have the shape of a sphere, a small particle diameter and a narrow particle diameter distribution. The polyester mother particle is explained.

The colored particle is preferably formed by dissolving or dispersing toner compositions including a polyester material including an active hydrogen group and a polyester resin reactable with the active hydrogen group (prepolymer (A)) in an organic solvent to prepare a solution or a dispersion, and dispersing the solution or dispersion in an aqueous medium including a particulate resin, and reacting the prepolymer (A) with a compound having an active hydrogen group. The toner compositions may include materials of the colored particle.

The prepolymer (A) is formed by reacting a polyester resin having an active hydrogen group which is a polycondensation product between a polyol (1) and a polycarboxylic (2) with polyisocyanate (3).

Specific examples of the active hydrogen group include hydroxyl groups (alcoholic hydroxyl groups and phenolic hydroxyl groups), amino groups, carboxyl groups, mercapto groups, etc. In particular, the alcoholic hydroxyl groups are preferably used.

Specific examples of the polyol (1) include alkylene glycol such as ethylene glycol, 1,2-propylene glycol, 1,3-propylene glycol, 1,4-butanediol, and 1,6-hexanediol; alkylene ether glycol such as diethylene glycol, triethylene glycol, dipropylene glycol, polyethylene glycol, polypropylene glycol and polytetramethylene ether glycol; alicyclic diol such as 1,4-cyclohexanedimethanol and hydrogenated bisphenol A; bisphenols such as bisphenol A, bisphenol F and bisphenol S; 4,4-dihydroxybiphenyls such as 3,3′-difluoro-4,4-dihydroxybiphenyl; bis(hydroxyphenyl)alkanes such as bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (tetrafluorobisphenol A), and 2,2-bis(3-hydroxyphenyl)-1,1,1,3,3,3-hexafluoropropane; bis(4-hydroxyphenyl)ethers such as a bis(3-fluoro-4-hydroxyphenyl)ether; adducts of the above-mentioned alicyclic diol with an alkylene oxide such as ethylene oxide, propylene oxide and butylene oxide; adducts of the above-mentioned bisphenol with an alkylene oxide such as ethylene oxide, propylene oxide and butylene oxide, etc. In particular, alkylene glycol having 2 to 12 carbon atoms and adducts of bisphenol with an alkylene oxide are preferably used, and a mixture thereof is more preferably used.

Further, multivalent aliphatic alcohol having 3 or more valences such as glycerin, trimethylolethane, trimethylolpropane, pentaerythritol and sorbitol; phenol having 3 or more valences such as trisphenol PA, phenolnovolak, cresolnovolak; and adducts of the above-mentioned polyphenol having 3 or more valences with an alkylene oxide can also be used. These polyols can be used alone or in combination, and are not limited thereto.

Specific examples of the polycarboxylic acids (2) include alkylene dicarboxylic acids such as a succinic acid, an adipic acid and a sebacic acid; alkenylene dicarboxylic acids such as a maleic acid and a fumaric acid; and aromatic dicarboxylic acids such as a phthalic acid, an isophthalic acid, a terephthalic acid and a naphthalene dicarboxylic acid, a 3-fluoroisophthalic acid, a 2-fluoroisophthalic acid, a 2-fluoroterephthalic acid, a 2,4,5,6-tetrafluoroisophthalic acid, a 5-trifluoromethylisophthalic acid, 2,2-bis(4-carboxyphenyl)hexafluoropropane, 2,2-bis(3-carboxyphenyl)hexafluoropropane, a 2,2′-bis(trifluoromethyl)-4,4′-biphenyl dicarboxylic acid, a 3,3′-bis(trifluoromethyl)-4,4′-biphenyldicarboxylic acid, a 2,2′-bis(trifluoromethyl)-3,3′-biphenyldicarboxylic acid, a hexafluoroisopropylidenediphthalic acid anhydride, etc. In particular, alkenylene dicarboxylic acid having 4 to 20 carbon atoms and aromatic dicarboxylic acid having 8 to 20 carbon atoms are preferably used.

Specific examples of the polycarboxylic acid having 3 or more valences include aromatic polycarboxylic acids having 9 to 20 carbon atoms such as a trimellitic acid and a pyromellitic acid. In addition, the polycarboxylic acid can be formed from a reaction between the polyol (1) and the above-mentioned acids anhydride or lower alkyl ester such as methyl ester, ethyl ester and isopropyl ester. These polycarboxylic acids can be used alone or in combination, and are not limited thereto.

The polyol and polycarboxylic acid are mixed such that an equivalent ratio ([OH]/[COOH]) between a hydroxyl group [OH] and a carboxylic group [COOH] is typically from 2/1 to 1/1, preferably from 1.5/1 to 1/1, and more preferably from 1.3/1 to 1.02/1.

The polyester resin preferably has a peak molecular weight of from 1,000 to 30,000, preferably from 1,500 to 10,000, and more preferably from 2,000 to 8,000. When less than 1,000, heat resistant preservability of the resultant toner occasionally deteriorates. When greater than 30,000, low-temperature fixability thereof occasionally deteriorates.

Specific examples of the polyisocyanate (3) include aliphatic polyisocyanate such as tetramethylenediisocyanate, hexamethylenediisocyanate and 2,6-diisocyanatemethylcaproate; alicyclic polyisocyanate such as isophoronediisocyanate and cyclohexylmethanediisocyanate; aromatic diisocyanate such as tolylenedisocyanate and diphenylmethanediisocyanate; aroma aliphatic diisocyanate such as α,α,α′,α′-tetramethylxylylenediisocyanate; isocyanurate; the above-mentioned polyisocyanate blocked with phenol derivatives, oxime and caprolactam; and their combinations.

The polyisocyanate (3) is mixed with polyester such that an equivalent ratio ([NCO]/[OH]) between an isocyanate group [NCO] and polyester having a hydroxyl group[OH]is typically from 5/1 to 1/1, preferably from 4/1 to 1.2/1 and more preferably from 2.5/1 to 1.5/1 when synthesizing the prepolymer (A). When [NCO]/[OH] is greater than 5, low temperature fixability of the resultant toner occasionally deteriorates. When [NCO] has a molar ratio less than 1, a urea content in ester of the modified polyester decreases and hot offset resistance of the resultant toner occasionally deteriorates.

The content of the constitutional component of a polyisocyanate in the polyester prepolymer (A) having a polyisocyanate group at its end portion is from 0.5% to 40% by weight, preferably from 1% to 30% by weight and more preferably from 2 to 20% by weight. When the content is less than 0.5% by weight, hot offset resistance of the resultant toner occasionally deteriorates. In contrast, when the content is greater than 40% by weight, low temperature fixability of the resultant toner occasionally deteriorates.

The number of the isocyanate groups included in a molecule of the polyester prepolymer (A) is at least 1, preferably from 1.5 to 3 on average, and more preferably from 1.8 to 2.5 on average. When the number of the isocyanate group is less than 1 per 1 molecule, the molecular weight of the modified polyester decreases and hot offset resistance of the resultant toner occasionally deteriorates.

Specific examples of amines (B) include diamines (B1), polyamines (B2) having three or more amino groups, amino alcohols (B3), amino mercaptans (B4), amino acids (B5) and blocked amines (B6) in which the amines (B1-B5) mentioned above are blocked.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophorone diamine); aliphatic diamines (e.g., ethylene diamine, tetramethylene diamine and hexamethylene diamine); etc.

Specific examples of the polyamines (B2) having three or more amino groups include diethylene triamine, triethylene tetramine.

Specific examples of the amino alcohols (B3) include ethanol amine and hydroxyethyl aniline.

Specific examples of the amino mercaptan (B4) include aminoethyl mercaptan and aminopropyl mercaptan.

Specific examples of the amino acids (B5) include amino propionic acid and amino caproic acid.

Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc.

The molecular weight of the modified polyester can optionally be controlled using an elongation anticatalyst, if desired.

Specific examples of the elongation anticatalyst include monoamines such as diethyle amine, dibutyl amine, butyl amine and lauryl amine, and blocked amines, i.e., ketimine compounds prepared by blocking the monoamines mentioned above.

The mixing ratio (i.e., a ratio [NCO]/[NHx]) of the content of the prepolymer (A) having an isocyanate group to the amine (B) is from 1/2 to 2/1, preferably from 1.5/1 to 1/1.5 and more preferably from 1.2/1 to 1/1.2. When the mixing ratio is greater than 2 or less than 1/2, molecular weight of the urea-modified polyester decreases, resulting in deterioration of hot offset resistance of the resultant toner.

An organic solvent dissolving or dispersing the toner compositions is preferably a volatile solvent having a boiling point less than 100° C. because the solvent can easily be removed afterwards.

Specific examples of such a solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. These solvents can be used alone or in combination.

Among these solvents, aromatic solvents such as toluene and xylene; and halogenated hydrocarbons such as methylene chloride, 1,2-dichloroethane, chloroform, and carbon tetrachloride are preferably used.

The toner compositions may be dissolved or dispersed at the same time, but typically they are dissolved or dispersed separately. The organic solvents used then may be different from each other, however, are preferably same in consideration of the solvent disposal afterwards.

A solution or a dispersion of polyester resins preferably has a resin concentration of from 40 to 80% by weight. When too high, the binder resin is difficult to dissolve or disperse in a solvent and has too high a viscosity to handle. When too low, the toner is not prepared much.

When a polyester resin and the prepolymer are mixed, they may be mixed in a same solution or a dispersion, or may be mixed after separately dissolved or dispersed. However, they are preferably mixed after separately dissolved or dispersed in consideration of their solubilities and viscosities.

The colorant may be dissolved or dispersed alone, or mixed in a solution or dispersion of a polyester resin. A dispersion auxiliary agent and a polyester resin may be added thereto when necessary, and a masterbatch may be used.

When a wax is dissolved or dispersed as a release agent, an organic solvent in which a wax is insoluble is used as a dispersion. The dispersion is prepared by typical methods. Namely, a wax is mixed in an organic solvent and the mixture is dispersed by a disperser such as beads mill.

In addition, after a wax is mixed in an organic solvent, the mixture is heated to have a melting point of the wax, cooled while stirred, and dispersed by a disperser such as beads mill to shorten the dispersion time.

Plural waxes may be mixed, and a dispersion auxiliary agent and a polyester resin may be added thereto.

The aqueous medium for use in the present invention includes water alone and mixtures of water with a solvent which can be mixed with water. Specific examples of the solvent include alcohols such as methanol, isopropanol and ethylene glycol; dimethylformamide; tetrahydrofuran; cellosolves (trademark) such as methyl cellosolve; and lower ketones such as acetone and methyl ethyl ketone. The aqueous medium is typically used in an amount of from 50 to 2,000 parts by weight per 100 parts by weight of the toner compositions, and preferably from 100 to 1,000 parts by weight. When less than 50 parts by weight, the toner compositions are not dispersed well occasionally. When greater than 2,000, it is not economical.

Before a solution or a dispersion of the polyester resins and the release agent is dispersed in the aqueous medium, an inorganic dispersant or an organic particulate resin is preferably dispersed therein because particle diameter distribution of the resultant toner becomes sharp and the solution or the dispersion is stably dispersed therein.

Specific examples of the inorganic dispersant include tricalcium phosphate, calcium carbonate, titanium oxide, colloidal silica, hydroxyapatite, etc.

Specific examples of the particulate resin include any thermoplastic and thermosetting resins capable of forming an aqueous dispersion such as vinyl resins, a polyurethane resin, an epoxy resin, a polyester resin, a polyamide resin, a polyimide resin, silicon resins, a phenol resin, a melamine resin, a urea resin, an aniline resin, an ionomer resin, a polycarbonate resin, etc. These resins can be used alone or in combination. Among these resins, the vinyl resins, the polyurethane resin, the epoxy resin, the polyester resin and their combinations are preferably used in terms of forming an aqueous dispersion of microscopic spherical particulate resins.

Methods of dispersing an organic particulate resin in an aqueous medium are not particularly limited, but include the following methods (a) to (h):

(a) polymerizing a vinyl monomer by a polymerization method such as a suspension polymerization method, an emulsion polymerization method, a seed polymerization method or a dispersion polymerization method to directly prepare an aqueous particulate resin dispersion;

(b) dispersing a precursor such as a monomer and an oligomer of polyaddition or polycondensed resins such as a polyester resin, a polyurethane resin and an epoxy resin or its solvent solution in an aqueous medium under the presence of a suitable dispersant to prepare a dispersion, and heating the dispersion and adding a hardener thereto to prepare an aqueous particulate resin dispersion;

(c) dissolving a suitable emulsifier in a precursor such as a monomer and an oligomer of polyaddition or polycondensed resins such as a polyester resin, a polyurethane resin and an epoxy resin or its solvent solution (preferably a liquid and may be heated to liquidate) to prepare a solution, and adding water thereto to phase-inversion emulsify;

(d) pulverizing a resin prepared by a polymerization reaction such as an addition polymerization reaction, a ring-opening polymerization reaction, polyaddition polymerization reaction, an addition condensation reaction and a condensation polymerization reaction with a pulverizer using a mechanical rotator or a jet to prepare a pulverized resin, classifying the pulverized resin to prepare a particulate resin, and dispersing the particulate resin in water under the presence of a suitable dispersant;

(e) dissolving a resin prepared by a polymerization reaction such as an addition polymerization reaction, a ring-opening polymerization reaction, polyaddition polymerization reaction, an addition condensation reaction and a condensation polymerization reaction in a solvent to prepare a resin solution, spraying the resin solution to prepare a particulate resin, and dispersing the particulate resin in water under the presence of a suitable dispersant;

(f) dissolving (while heating) a resin prepared by a polymerization reaction such as an addition polymerization reaction, a ring-opening polymerization reaction, polyaddition polymerization reaction, an addition condensation reaction and a condensation polymerization reaction in a solvent to prepare a resin solution, adding a solvent thereto (or cooling the resin solution) to separate out a particulate resin, removing the solvent from the particulate resin, and dispersing the particulate resin in water under the presence of a suitable dispersant;

(g) dissolving a resin prepared by a polymerization reaction such as an addition polymerization reaction, a ring-opening polymerization reaction, polyaddition polymerization reaction, an addition condensation reaction and a condensation polymerization reaction in a solvent to prepare a resin solution, dispersing the resin solution in an aqueous medium under the presence of a suitable dispersant to prepare a dispersion, and heating or depressurizing the dispersion to remove the solvent therefrom; and

(h) dissolving a resin prepared by a polymerization reaction such as an addition polymerization reaction, a ring-opening polymerization reaction, polyaddition polymerization reaction, an addition condensation reaction and a condensation polymerization reaction in a solvent to prepare a resin solution, dissolving a suitable emulsifier therein, and adding water thereto to phase-inversion emulsify.

Surfactants can be used to emulsify or disperse a solution or a dispersion including toner compositions in an aqueous medium when necessary.

Specific examples thereof include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammonium betaine.

A surfactant having a fluoroalkyl group can prepare a dispersion having good dispersibility even when a small amount of the surfactant is used.

Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4)sulfonate, sodium-{omega-fluoroalkanoyl(C6-C8)-N-ethylamino}-1-propanesulfonate, fluoroalkyl(C11-C20)carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the cationic surfactants include primary, secondary and tertiary aliphatic amines having a fluoroalkyl group, aliphatic quaternary ammonium salts such as perfluoroalkyl(C6-C10)sulfoneamidepropyltrimethylammonium salts, benzalkonium salts, benzetonium chloride, pyridinium salts, imidazolinium salts, etc.

Further, it is possible to stabilize dispersed droplets with a polymeric protection colloid in combination with the inorganic dispersants and/or particulate polymers mentioned above.

Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., (β-hydroxyethyl acrylate, (β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

When an acid such as calcium phosphate or a material soluble in alkaline is used as a dispersant, the calcium phosphate is dissolved with an acid such as a hydrochloric acid and washed with water to remove the calcium phosphate from a toner. Besides this method, it can also be removed by an enzymatic hydrolysis. When a dispersant is used, the dispersant may remain on the surface of a toner, but is preferably washed to remove in terms of the chargeability thereof.

The dispersion method is not particularly limited, and low speed shearing methods, high-speed shearing methods, friction methods, high-pressure jet methods, ultrasonic methods, etc. can be used. A high-speed shearing type dispersion machine is preferably used to form dispersed materials having an average particle diameter of from 2 to 20 μm. When the high-speed shearing type dispersion machine is used, the rotation speed is not particularly limited, but the rotation speed is typically from 1,000 to 30,000 rpm, and preferably from 5,000 to 20,000 rpm. The dispersion time is not particularly limited, but typically from 0.1 to 5 min in batch methods. The temperature in the dispersion process is typically from 0° C. to 150° C. (under pressure), and preferably from 20° C. to 80° C.

In order to remove the organic solvent from the obtained emulsified dispersion liquid, a method where the entire liquid is gradually heated to completely evaporate and remove the organic solvent contained in the dispersed droplets can be employed.

It is also possible that the emulsified dispersion liquid is sprayed in a dry atmosphere to completely evaporate and remove the water-insoluble organic solvent in the droplets to thereby form toner particles, at the same time as evaporating and removing the aqueous dispersant.

As for the dry atmosphere in which the emulsified dispersion liquid is sprayed, heated gas (e.g., air, nitrogen, carbon dioxide and combustion gas), especially, gas flow heated to temperature equal to or higher than the boiling point of the solvent for use, is generally used. The treatment of a short period by a spray dryer, a belt dryer or a rotary kiln can sufficiently provide the intended quality.

Amines (B) may be mixed in an organic solvent before dispersing toner compositions in an aqueous medium, or added thereto.

The reaction time between the prepolymer (A) and the amines (B) depends on their reactivity, but typically from 1 min to 40 hrs, and preferably from 1 to 24 hrs. The reaction temperature is typically from 0° C. to 150° C., and preferably from 20° C. to 98° C. A known catalyst can be used when necessary.

Known methods are used to wash and dry the toner particles dispersed in an aqueous medium.

Namely, subjecting the colored particles dispersed in an aqueous medium to a solid-liquid separation with a centrifugal separator or a filter press to prepare a toner cake; dispersing again the toner cake in ion-exchange water having a room temperature to 40° C. while controlling pH with an acid or an alkali when necessary; repeating subjecting the toner cake to a solid-liquid separation for several times to remove impurities or surfactant therefrom; and drying the toner cake with a drier such as a flash drier, a circulation drier, a decompression drier and a vibration fluidization drier to prepare a toner powder. Fine toner particles may be removed therefrom with a centrifugal separator or the toner powder can have a desired particle diameter distribution with a known classifier when necessary.

In order to improve fluidity, preservability, developability and transferability of the toner, the thus prepared parent toner can be mixed with an inorganic particulate material (external additive). Suitable mixers for use in mixing the mother toner particles and an external additive include known mixers for mixing powders, which preferably have a jacket to control the inside temperature thereof. By changing the timing when the external additive is added or the addition speed of the external additive, the stress on the external additive can be changed. Of course, by changing rotating number of the blade of the mixer used, mixing time, mixing temperature, etc., the stress can also be changed.

In addition, a mixing method in which at first a relatively high stress is applied and then a relatively low stress is applied to the external additive, or vice versa, can also be used. Specific examples of the mixers include V-form mixers, locking mixers, Loedge Mixers, NAUTER MIXERS, HENSCHEL MIXERS and the like mixers.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### [Preparation of Intermediate Transfer Belt]

### [Preparation of Intermediate Transfer Belt 1]

A coating liquid for substrate was prepared by the following method to prepare an intermediate transfer belt 31-1.

### <Preparation of Coating Liquid for Substrate>

First, a dispersion including carbon black (Special Black 4 from Evonik Degussa GmbH dispersed in N-methyl-2-pyrrolidone by beads mill was well mixed in polyimide varnish (U-varnish A from UBE INDUSTRIES, LTD.) so as to include carbon black in an amount of 17% by weight based on total weight of a polyamic acid solid content to prepare a coating liquid.

### <Preparation of Intermediate Transfer Belt Substrate>

A blasted metallic cylindrical substrate having an outer diameter of 340 mm and a length of 360 mm was used as a mold to be set on a roll coater. Next, the coating liquid was placed in a pan and drawn at a rotational speed of 40 mm/sec with a gap of 0.6 mm between a regulation roller and a coating roller to control the thickness of the coating liquid on the coating roller. Then, the cylindrical substrate was put close to the coating roller at a rotational speed of 30 mm/sec with a gap of 0.4 mm with the coating roller to uniformly transfer the coating liquid thereon onto the cylindrical substrate. The coated cylindrical substrate was placed in a hot air circulation drier and gradually heated up to 110° C. and heated thereat for 30 min, and further heated at 200° C. for 30 min and the rotation of the cylindrical substrate was stopped. Then, the cylindrical substrate was placed in a high-temperature heating (firing) furnace and heated in stages up to 320° C., and heated (fired) thereat for 60 min.

<Formation of Elastic body on Substrate>

The following materials were fully kneaded by a biaxial kneader to prepare a rubber composition.

<Elastic body Composition>

| | | |
|---|---|---|
| Acrylic rubber | Nipol AR12 from ZEON CORP. | 100 |
| Stearic acid | Beads stearic acid TSUBAKI from | 1 |
| | NOF CORP. | |
| Red phosphorus | Novaexcel 140F from | 10 |
| | RIN KAGAKU KOGYO Co., Ltd. | |
| Aluminum hydroxide | HIGILITE H42M from | 60 |
| | SHOWA DENKO K.K. | |
| Crosslinker | Diak. No 1 (hexamethylenediamine | 0.6 |
| | carbamate from DuPont Dow | |
| | Elastomers Japan) | |
| Crosslinking promoter | VULCOFAC ACT55 | 1 |
| | (70% salt of 1,8-diazabicyclo | |
| | (5, 4, 0) undecene-7 and dibasic | |
| | acid 30% amorphous silica from | |
| | Safic Alcan) | |
| Conductivizer | QAP-01 (tetrabutylammonium | 0.3 |
| | perchlorate from Japan Carlit Co., Ltd.) | |

Next, the rubber composition was dissolved in an organic solvent (methylisobutylketone) to prepare a rubber solution including a solid content in an amount of 35% by weight. The rubber solution was continuously discharged from a nozzle to be spirally coated on the polyimide base material formed on the cylindrical substrate in an axial direction thereof while rotated. The rubber solution was coated so as to form the final rubber layer having a thickness of 500 μm. When the rubber solution was evenly spread over the base material, a spherical particulate material 31-3 was coated on the rubber layer by the particulate material applicator in FIG. 3.

A particulate silicone resin (Tospearl 130 from Momentive Performance Materials, Inc., having a volume-average particle diameter of 3.0 μm) was used as the spherical particulate material 31-3.

After the particulate material was coated on the rubber layer, the cylindrical substrate was placed in a hot air circulation drier while rotated and heated for 30 min up to 90° C. at a rate of temperature increase of 4° C./min. Further, the cylindrical substrate was heated for 60 min up to 170° C. at a rate of temperature increase of 4° C./min. After heated, it was gradually cooled. After fully cooled, it was taken out of the mold to prepare an intermediate transfer belt 1.

The intermediate transfer belt 1 had a surface electrical resistance of 5×10¹⁰ Ω/□, a volume electrical resistance of 1×10¹⁰ Ω/□, a compression Young's modulus of 40 N/mm² and a surface roughness of 10 μm.

### [Preparation of Intermediate Transfer Belt 2]

The procedure for preparation of the intermediate transfer belt 1 was repeated to prepare an intermediate transfer belt 2 except for changing the content of the carbon black from 17% by weight to 10% by weight in the Preparation of Coating Liquid for Substrate.

The intermediate transfer belt 2 had a surface electrical resistance of 1×10¹¹ Ω/□, a volume electrical resistance of 5×10¹⁰ Ω/□, a compression Young's modulus of 40 N/mm² and a surface roughness of 10 μm.

### [Preparation of Intermediate Transfer Belt 3]

The procedure for preparation of the intermediate transfer belt 1 was repeated to prepare an intermediate transfer belt 3 except for changing the thickness of the rubber layer from 500 μm to 100 μm.

The intermediate transfer belt 3 had a surface electrical resistance of 5×10¹⁰ Ω/□, a volume electrical resistance of 1×10¹⁰ Ω/□, a compression Young's modulus of 200 N/mm² and a surface roughness of 10 μm.

### [Preparation of Intermediate Transfer Belt 4]

The procedure for preparation of the intermediate transfer belt 1 was repeated to prepare an intermediate transfer belt 4 except for changing the particulate silicone resin Tospearl 130 having a volume-average particle diameter of 3.0 μm to Tospearl 1110 having a volume-average particle diameter of 11.0 μm from Momentive Performance Materials, Inc.

The intermediate transfer belt 4 had a surface electrical resistance of 5×10¹⁰ Ω/□, a volume electrical resistance of 1×10¹⁰ Ω/□, a compression Young's modulus of 200 N/mm² and a surface roughness of 100 μm.

### [Preparation of Intermediate Transfer Belt 5]

The procedure for preparation of the intermediate transfer belt 1 was repeated to prepare an intermediate transfer belt 5 except for changing the particulate silicone resin to an acrylic resin.

The intermediate transfer belt 5 had a surface electrical resistance of 5×10¹⁰ Ω/□, a volume electrical resistance of 1×10¹⁰ Ω/□, a compression Young's modulus of 40 N/mm² and a surface roughness of 10 μm.

Properties of the intermediate transfer belts 1 to 5 are shown in Table 1.

TABLE 1

| | Electrical | | | | | | |
|---|---|---|---|---|---|---|---|
| | Resistance | Belt | | | | | |
| | Controlling | Surface | Rubber | | | Surface | Volume |
| | Material (% | Roughness | Thickness | Particulate | Type of | Resistivity | Resistivity |
| | by wt.) | (μm) | (μm) | Resin (μm) | Resin | (EΩ/□) | (EΩ/□) |
| Intermediate | 17 | 10 | 500 | 3.0 | Silicone | 5 × 10¹⁰ | 1 × 10¹⁰ |
| Transfer Belt 1 | | | | | | | |
| Intermediate | 10 | 10 | 500 | 3.0 | Silicone | 5 × 10¹¹ | 5 × 10¹⁰ |
| Transfer Belt 2 | | | | | | | |
| Intermediate | 17 | 10 | 100 | 3.0 | Silicone | 5 × 10¹⁰ | 1 × 10¹⁰ |
| Transfer Belt 3 | | | | | | | |
| Intermediate | 17 | 100 | 500 | 11.0 | Silicone | 5 × 10¹⁰ | 1 × 10¹⁰ |
| Transfer Belt 4 | | | | | | | |
| Intermediate | 17 | 100 | 500 | 3.0 | Acrylic | 5 × 10¹⁰ | 1 × 10¹⁰ |
| Transfer Belt 5 | | | | | | | |

### [Preparation of Toner]

After a toner material liquid (oil phase) was emulsified or dispersed in an aqueous medium (phase), a solvent was removed from the emulsified or dispersed toner material liquid to prepare a granulated (colored) particulate material which was a mother particle. One part by weight of a chrome-containing metal complex dye was fixed on the mother particle material as a charge controlling agent.

### [Preparation of Toner 1]

### (Synthesis of Particulate Dispersion)

Seven hundred (700) parts of water, 12 parts of a sodium salt of an adduct of a sulfuric ester with ethyleneoxide methacrylate (ELEMINOL RS-30 from Sanyo Chemical Industries, Ltd.), 85 parts of styrene, 85 parts of methacrylate, 110 parts of butylacrylate and 1 part of persulfate ammonium were mixed in a reactor vessel including a stirrer and a thermometer, and the mixture was stirred for 15 min at 400 rpm to prepare a white emulsion therein. The white emulsion was heated to have a temperature of 75° C. and reacted for 5 hrs. Further, 30 parts of an aqueous solution of persulfate ammonium having a concentration of 1% were added thereto and the mixture was aged for 5 hrs at 75° C. to prepare an aqueous dispersion [particulate dispersion] of a vinyl resin (a copolymer of styrene-methacrylate-butylacrylate-sodium salt of ethylene-oxide-adduct sulfate of methacrylic acid).

The [particulate dispersion 1] was measured by LA-920 to find a weight-average particle diameter thereof was 105 nm.

A part of the [particulate dispersion 1] was dried to isolate resins therefrom. The resin had a Tg of 60° C. and a weight-average molecular weight of 160,000.

### (Preparation of Aqueous Phase)

Nine hundred and ninety (990) parts of water, 83 parts of the [particulate dispersion], 40 parts of an aqueous solution of sodium dodecyldiphenyletherdisulfonate having a concentration of 48.5% (ELEMINOL MON-7 from Sanyo Chemical Industries, Ltd.) and 90 parts of ethyl acetate were mixed and stirred to prepare a lacteous liquid an [aqueous phase 1].

### (Synthesis of Low-Molecular-Weight Polyester)

Two hundred twenty nine (229) parts of an adduct of bisphenol A with 2 moles of ethyleneoxide, 529 parts of an adduct of bisphenol A with 3 moles of propyleneoxide, 208 parts terephthalic acid, 46 parts of adipic acid and 2 parts of dibutyltinoxide were reacted in a reactor vessel including a cooling pipe, a stirrer and a nitrogen inlet pipe for 8 hrs at a normal pressure and 230° C. Further, after the mixture was depressurized by 10 to 15 mm Hg and reacted for 5 hrs, 44 parts of trimellitic acid anhydride were added thereto and the mixture was reacted for 2 hrs at a normal pressure and 180° C. to prepare a [low-molecular-weight polyester 1].

The [low-molecular-weight polyester 1] had a number-average molecular weight of 2,500, a weight-average molecular weight of 6,700, a Tg of 43° C. and an acid value of 25 mg KOH/g.

### (Preparation of Intermediate Polyester and Prepolymer)

Six hundred eighty two (682) parts of an adduct of bisphenol A with 2 moles of ethyleneoxide, 81 parts of an adduct of bisphenol A with 2 moles of propyleneoxide, 283 parts terephthalic acid, 22 parts of trimellitic acid anhydride and 2 parts of dibutyltinoxide were mixed and reacted in a reactor vessel including a cooling pipe, a stirrer and a nitrogen inlet pipe for 8 hrs at a normal pressure and 230° C. Further, after the mixture was depressurized to 10 to 15 mm Hg and reacted for 5 hrs to prepare an [intermediate polyester 1]. The [intermediate polyester 1] had a number-average molecular weight of 2,100, a weight-average molecular weight of 9,500, a Tg of 55° C. and an acid value of 0.5 and a hydroxyl value of 51 mg KOH/g.

Next, 410 parts of the [intermediate polyester 1], 89 parts of isophoronediisocyanate and 500 parts of ethyl acetate were reacted in a reactor vessel including a cooling pipe, a stirrer and a nitrogen inlet pipe for 5 hrs at 100° C. to prepare a [prepolymer 1]. The [prepolymer 1] included a free isocyanate in an amount of 1.53% by weight.

### (Synthesis of Ketimine)

One hundred seventy (170) parts of isophoronediamine and 75 parts of methyl ethyl ketone were reacted at 50° C. for 5 hrs in a reaction vessel including a stirrer and a thermometer to prepare a [ketimine compound].

The [ketimine compound] had an amine value of 418 mg KOH/g.

### (Synthesis of Masterbatch)

Thirty five (35) parts of water, 40 parts of phthalocyanine pigment FG7351 from Toyo Ink Co., Ltd., and 60 parts of a polyester resin RS801 from Sanyo Chemical Industries, Ltd. were mixed by a Henschel Mixer from Mitsui Mining Co., Ltd. After the mixture was kneaded by a two-roll mill having a surface temperature of 150° C. for 30 min, the mixture was extended by applying pressure, cooled and pulverized by a pulverizer to prepare a [masterbatch for cyan toner].

### (Preparation of Oil Phase)

Three hundred seventy eight (378) parts of the [low-molecular-weight polyester 1], 110 parts of carnauba wax, 22 parts of a charge controlling agent (salicylic acid metal complex) E-84 from orient Chemical Industries Co., Ltd. and 947 parts of ethyl acetate were mixed in a reaction vessel including a stirrer and a thermometer. The mixture was heated to have a temperature of 80° C. while stirred. After the temperature of 80° C. was maintained for 5 hrs, the mixture was cooled to have a temperature of 30° C. in an hour. Then, 500 parts of the [masterbatch 1] and 500 parts of ethyl acetate were added to the mixture and mixed for 1 hr to prepare a [material solution].

One thousand three hundred twenty four (1,324) parts of the [material solution] were transferred into another vessel, and the carbon black Printex 35 from Degussa GmbH and the wax therein were dispersed by a beads mill (Ultra Visco Mill from IMECS CO., LTD.) for 3 passes under the following conditions:

liquid feeding speed of 1 kg/hr; peripheral disc speed of 6 msec; and filling zirconia beads having diameter of 0.5 mm for 80% by volume.

Next, 1,324 parts of an ethyl acetate solution of the [low-molecular-weight polyester] having a concentration of 65% were added to the [material solution] and the mixture was stirred by the beads mill for 1 pass under the same conditions to prepare a [pigment and wax dispersion liquid].

The [pigment and wax dispersion liquid] had a solid content concentration of 50% at 130° C. for 30 min.

### (Emulsification)

Six hundred forty eight (648) parts of the [pigment and wax dispersion liquid], 154 parts of the [prepolymer] and 6.6 parts of the [ketimine compound] were mixed in a vessel by a TK homomixer from Tokushu Kika Kogyo Co., Ltd. at 5,000 rpm for 1 min. One thousand two hundred (1,200) parts of the [aqueous phase 1] were added to the mixture and mixed by the TK homomixer at 13,000 rpm for 20 min to prepare an [emulsified slurry].

Three point fifteen (3.15) parts of Serogen BS-H from DKS CO., Ltd. were added little by little in 75.6 parts of ion-exchanged water while stirred by a TK homomixer from Tokushu Kika Kogyo Co., Ltd. at 2,000 rpm. After added therein, the mixture was stirred for 30 min at 20° C. Forty three point three 43.3 parts of an aqueous solution of sodium dodecyldiphenyletherdisulfonate having a concentration of 48.5% (ELEMINOL MON-7 from Sanyo Chemical Industries, Ltd.) were added to the resultant Serogen solution, and the mixture was stirred for 5 min at 20° C. Two thousands (2,000) parts of the [emulsified slurry] were added to the resultant mixture and the mixture was mixed at 2,000 rpm for 1 hr to prepare a [shape-controlling slurry].

### (De-Solvent)

The [shape-controlling slurry] was put in a vessel including a stirrer and a thermometer. After a solvent was removed from the emulsified slurry 1 at 30° C. for 8 hrs, the slurry was aged at 40° C. for 24 hrs to prepare a [dispersion slurry].

### (Washing and Drying)

After 100 parts the [dispersion slurry] was filtered under reduced pressure to prepare a filtered cake, the following washings and filtrations were repeated.

(1) 100 parts of ion-exchange water were added to the filtered cake and mixed by the TK homomixer at 12,000 rpm for 10 min, and the mixture was filtered to prepare a filtered cake (b).

(2) 100 parts of an aqueous solution of 10% sodium hydrate were added to the filtered cake in (1) and mixed by the TK homomixer at 12,000 rpm for 30 min, and the mixture was filtered under reduced pressure to prepare a filtered cake.

(3) 100 parts of 10% hydrochloric acid were added to the filtered cake in (2) and mixed by the TK homomixer at 12,000 rpm for 10 min, and the mixture was filtered to prepare a filtered cake.

(4) 300 parts of ion-exchange water were added to the filtered cake in (3) and mixed by the TK homomixer at 12,000 rpm for 10 min, and the mixture was filtered. This operation was repeated again to prepare a [washed and filtered cake].

The [washed and filtered cake] was dried by an air drier at 45° C. for 48 hrs and sieved by a mesh having an opening of 75 μm to prepare [toner mother particles] having a volume-average particle diameter of 6.0 μm.

Finally, 1 part of a large-size silica and 3 parts of a small-size silica and 2 parts of titanium oxide were mixed with 100 parts of the [mother toner particles] by a HENSCHEL MIXER to prepare a toner 1 having the mother particle.

The large-size silica had a particle diameter of 60 nm and a coverage over the particle of 7%, and a (large-size silica+small-size silica)/titanium oxide ratio was 2. The large-size silica, the small-size silica and the titanium oxide were all hydrophobized.

### [Preparation of Toner 2]

The procedure for preparation of the toner 1 was repeated to prepare a toner 2 except for changing 1 part of the large-size silica into 4 parts thereof, the coverage 7% into 30%, and the (large-size silica+small-size silica)/titanium oxide ratio 2 into 3.5.

### [Preparation of Toner 3]

The procedure for preparation of the toner 1 was repeated to prepare a toner 3 except for changing 1 part of the large-size silica into 0.5 parts thereof, the coverage 7% into 3.5%, 3 parts of the small-size silica, and the (large-size silica+small-size silica)/titanium oxide ratio 2 into 0.75.

### [Preparation of Toner 4]

The procedure for preparation of the toner 1 was repeated to prepare a toner 4 except for changing the particle diameter of 60 nm of the large-size silica into 200 nm.

### [Preparation of Toner 5]

The procedure for preparation of the toner 1 was repeated to prepare a toner 5 except for changing 1 part by weight of a chrome-containing metal complex dye as a charge controlling agent into 0.05 parts thereof.

Additives of the toners 1 to 5 are shown in Table 2.

TABLE 2

| | | (Large- | | |
|---|---|---|---|---|
| | | Size Silica + | Particle | |
| | Coverage | Small- | Diameter | Charge |
| | of Large- | Size Silica)/ | of Large- | Controlling |
| | Size Silica | Titanium | Size Silica | Agent |
| | (%) | Oxide Ratio | (μm) | (Wt. %) |
| Toner 1 | 7 | 2.0 | 60 | 1 |
| Toner 2 | 30 | 3.5 | 60 | 1 |
| Toner 3 | 3.5 | 0.75 | 60 | 1 |
| Toner 4 | 7 | 2.0 | 200 | 1 |
| Toner 5 | 7 | 2.0 | 60 | 0.05 |

### Example 1

A print test was made using the intermediate transfer belt 1 and a developer of the toner 1 at a system speed shown in Table 3. A modified RICOH Pro c901 from Ricoh Company, Ltd. was used in the print test.

### Measurement of System Speed

One hundred (100) A4 (having a length of 297 mm in paper feeding direction) images were continuously produced. The system speed B was determined by the following formula.

B(mm/sec)=100×209 mm/A sec

wherein A is a time from start to finish.

Fifty thousand (50,000) test images having a printed rate of 6% were produced on A3 size papers. Then, a halftone image was produced on 3 A3 size papers as sample images to visually evaluate the void images. The sample images were compared with a previously prepared reference halftone image.

### [Visual Evaluation of Void Images]

Excellent: Rank 5

Good: Rank 4

Fair: Rank 3

Poor: Rank 2

Very poor: Rank 1

The higher the rank, the more correctly the toner is placed on a paper. The lower the rank, the less the toner transfers, resulting in white spots. The rank 4 or more was acceptable. The evaluation can be replaced with a measured value which is one of granularity. However, the measured value was not enough to express and a criteria sample was used.

### Example 2

The procedure for the print test in Example 1 was repeated except for changing the system speed from 2,000 mm/sec to 400 mm/sec.

### Comparative Example 1

The procedure for the print test in Example 2 was repeated except for changing the content of the carbon black in the intermediate transfer belt from 17% by weight into 10% by weight.

### Comparative Example 2

The procedure for the print test in Example 2 was repeated except for changing the intermediate transfer 1 belt into the intermediate transfer belt 3.

### Comparative Example 3

The procedure for the print test in Example 2 was repeated except for changing the intermediate transfer 1 belt into the intermediate transfer belt 4.

### Example 3

The procedure for the print test in Example 2 was repeated except for changing the intermediate transfer 1 belt into the intermediate transfer belt 5.

### Example 4

The procedure for the print test in Example 2 was repeated except for changing the toner 1 into the toner 2.

### Comparative Example 4

The procedure for the print test in Example 2 was repeated except for changing the toner 1 into the toner 3.

### Example 5

The procedure for the print test in Example 2 was repeated except for changing the toner 1 into the toner 4.

### Comparative Example 5

The procedure for the print test in Example 2 was repeated except for changing the toner 1 into the toner 5.

The results are shown in Table 3.

TABLE 3

| | System Liner | Intermediate | | |
|---|---|---|---|---|
| | Speed | Transferer | Toner | Void |
| | (mm/sec) | Belt | (Developer) | Image |
| Example 1 | 2,000 | Intermediate | Toner 1 | Good |
| | | Transfer Belt 1 | | |
| Example 2 | 400 | Intermediate | Toner 1 | Good |
| | | Transfer Belt 1 | | |
| Comparative | 400 | Intermediate | Toner 1 | Fair |
| Example 1 | | Transfer Belt 2 | | |
| Comparative | 400 | Intermediate | Toner 1 | Poor |
| Example 2 | | Transfer Belt 3 | | |
| Comparative | 400 | Intermediate | Toner 1 | Poor |
| Example 3 | | Transfer Belt 4 | | |
| Example 3 | 400 | Intermediate | Toner 1 | Good |
| | | Transfer Belt 5 | | |
| Example 4 | 400 | Intermediate | Toner 2 | Good |
| | | Transfer Belt 1 | | |
| Comparative | 400 | Intermediate | Toner 3 | Poor |
| Example 4 | | Transfer Belt 1 | | |
| Example 5 | 400 | Intermediate | Toner 4 | Good |
| | | Transfer Belt 1 | | |
| Comparative | 400 | Intermediate | Toner 5 | Poor |
| Example 5 | | Transfer Belt 1 | | |

Having now fully described the invention, it will be apparent to one of ordinary skill in the art that many changes and modifications can be made thereto without departing from the spirit and scope of the invention as set forth therein.

What is claimed is:

1. An image forming apparatus having a system speed of from 400 to 2,000 mm/sec and comprising an endless intermediate transfer belt configured to transfer a sheet-shaped medium bearing an image formed of a toner,
wherein the intermediate transfer belt comprises:
a first layer including at least a substrate;
a second layer having a thickness of from 200 to 2,000 μm and overlying the first layer, formed of an elastic body, on the surface of which spherical particulate resins having a volume-average particle diameter of from 0.5 to 5.0 μm are located in a surface direction to form concavities and convexities; and
an electric resistance controlling material,
the intermediate transfer belt having a surface resistivity of from 1×10⁸ to 1×10¹³ Ω/□, a volume resistivity of from 1×10⁶ to 1×10¹² Ω·cm, and a surface roughness not greater than 50 μm; and the toner comprises a mother particle which is surface-treated with a fluidizer, comprising a charge controlling agent and at least two external additives which are inorganic particulate materials and particulate polymers formed of polymeric particulate materials or thermosetting resins adhering to the surface of the mother particle.

2. The image forming apparatus of claim 1, wherein the substrate of the intermediate transfer belt comprises a resin including at least a polyimide or polyamide imide component, or a fluorine resin component; and an electrical resistance adjuster in the resin.

3. The image forming apparatus of claim 1, wherein the second layer has a surface resistivity of from 1×10⁸ to 1×10¹³ Ω/□.

4. The image forming apparatus of claim 1, wherein the electrical resistance controlling material is a member selected from the group consisting of carbon black, metals, metal oxides, metal suboxides and organic ionic onium salts in an amount of from 0.5% to 30% by weight based on total weight of the solid contents.

5. The image forming apparatus of claim 1, wherein the elastic body of the intermediate transfer belt has a compression Young's modulus of from 0.5 to 80.0 Mpa/m² in a stress range of from 3 to 50 N/mm².

6. The image forming apparatus of claim 1, wherein the elastic body of the second layer partially comprises a curable resin.

7. The image forming apparatus of claim 1, wherein at least one of the external additives of the toner is a large-size silica having a particle diameter of from 25 to 270 nm.

8. The image forming apparatus of claim 7, wherein the large-size silica has a coverage over the mother particle of from 5% to 45%.

9. The image forming apparatus of claim 1, wherein the toner comprises a large-size silica, a small-size silica and titanium oxide as the external additives in an amount of from 0.1 to 12 parts by weight, and a ratio of the large-size silica and the small-size silica to the titanium oxide is from 1 to 10.

10. The image forming apparatus of claim 1, wherein the toner comprises the charge controlling agent on an amount of from 0.2 to 5 parts by weight.
